(19) United States
(12) Patent Application Publication
(10) Pub. No.: US 2026/0164018 A1
(43) Pub. Date: Jun. 11, 2026

(54) LOW LATENCY SCHEME FOR SEMI DECOUPLED PARTITIONING

(71) Applicant: Tencent America LLC, Palo Alto, CA (US)

(72) Inventors: Jayasingam ADHURAN, Palo Alto, CA (US); Liang ZHAO, Palo Alto, CA (US); Madhu PERINGASSERY KRISHNAN, Palo Alto, CA (US); Tianqi LIU, Palo Alto, CA (US); Ting-Lan LIN, Palo Alto, CA (US); Shan LIU, Palo Alto, CA (US)

(21) Appl. No.: 19/366,487

(22) Filed: Oct. 22, 2025

Related U.S. Application Data
(60) Provisional application No. 63/729,894, filed on Dec. 9, 2024.

(51) Int. Cl. H04N 19/105; H04N 19/159; H04N 19/176; H04N 19/593

(52) U.S. Cl. CPC H04N 19/105; H04N 19/159; H04N 19/176; H04N 19/593

(57) ABSTRACT

An example method of video coding includes receiving a video bitstream including a plurality of blocks including a current block. The method includes, first partitioning is applied to the current block, reconstructing the current block by applying a chroma-from-luma (CfL) mode; and when second partitioning is applied to the current block, reconstructing the current block without using the CfL mode.

### RELATED APPLICATIONS

This application claims priority to U.S. Provisional Patent Application No. 63/729,894, entitled “Low Latency Scheme for Semi Decoupled Partitioning,” filed Dec. 9, 2024, which is hereby incorporated by reference in its entirety.

### TECHNICAL FIELD

The disclosed embodiments relate generally to video coding, including but not limited to systems and methods for block partitioning.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

### SUMMARY

The present disclosure describes amongst other things, a set of methods for video (image) compression, more specifically related to block partitioning and coding of signaled syntax elements, e.g., based on a shape of the current block. Some embodiments include using coded information (e.g., relating to the current block and/or neighboring blocks) as a context for a probability model used to entropy encode one or more signaled flags. Using coded information, such as a shape of the current block, as context may reduce hardware buffer requirements, e.g., by grouping multiple different sizes of the current block having the same shape into a single index, as compared to implementations in which every size of the current block has its own index. By taking into account a height/width ratio of the current block, coding loss may be reduced even while grouping blocks of different sizes. Coding accuracy may also be improved by taking into account the partitioning context of neighboring blocks.

In accordance with some embodiments, a method of video decoding includes (i) receiving a video bitstream (e.g., a coded video sequence) comprising a plurality of blocks including a current block; (ii) when first partitioning is applied to the current block, reconstructing the current block by applying a chroma-from-luma (CfL) mode; and (iii) when second partitioning is applied to the current block, reconstructing the current block without using the CfL mode.

In accordance with some embodiments, a method of video encoding includes (i) receiving video data (e.g., a source video sequence) comprising a plurality of blocks, including a current block; (ii) when first partitioning is applied to the current block, encoding the current block by applying a chroma-from-luma (CfL) mode; and (iii) when second partitioning is applied to the current block, encoding the current block without using the CfL mode.

In accordance with some embodiments, a method of video media bitstream generation includes: (i) generating a video bitstream, including: (a) when first partitioning is applied to the current block, reconstructing the current block by applying a chroma-from-luma (CfL) mode; and (b) when second partitioning is applied to the current block, reconstructing the current block without using the CfL mode; and (ii) transmitting the video bitstream including the encoded current block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A, 4B, and 4C illustrate examples of partitioning of coding blocks in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques restricting the use of chroma-from-luma (CfL) mode based on luma and chroma partition types to reduce latency between the decoding of the chroma block and the decoding of the collocated luma block. The decoding process of chroma blocks in the CfL mode may need to wait until the decoding process of collocated luma blocks is completed. The disclosed techniques address this latency issue by implementing conditional checking (e.g., at the 64×64 block level), where CfL is allowed only when specific conditions are met. Example conditions include (1) when the chroma partition is PARTITION_NONE, or (2) when the chroma block splits in the same direction as the partition of the collocated luma block, irrespective of transform partition directions. Some of the techniques are applicable in semi-decoupled partitioning (SDP) scenarios where luma and chroma may have different block partitioning, e.g., starting from 64×64. Advantages of restricting the use of CfL mode may include reducing hardware requirements, and ensuring that the chroma block only waits a maximum of 2048 luma samples to be reconstructed, reducing the encoding and/or decoding time of a current block, e.g., and achieving significant time savings (up to 3% decoding time reduction) with minimal coding loss (as low as 0.02% for low delay configurations).

### Example Systems and Devices

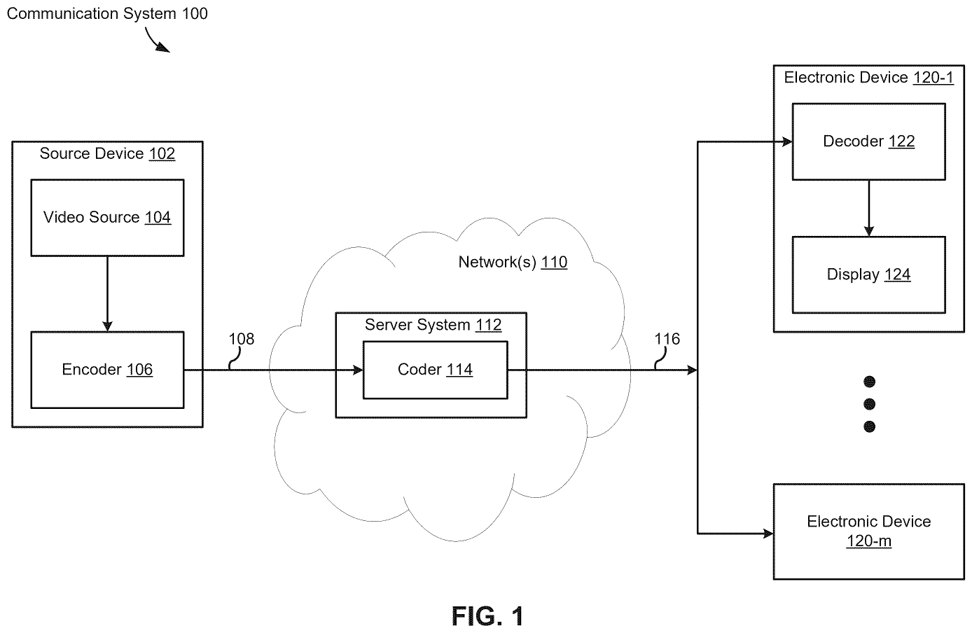

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

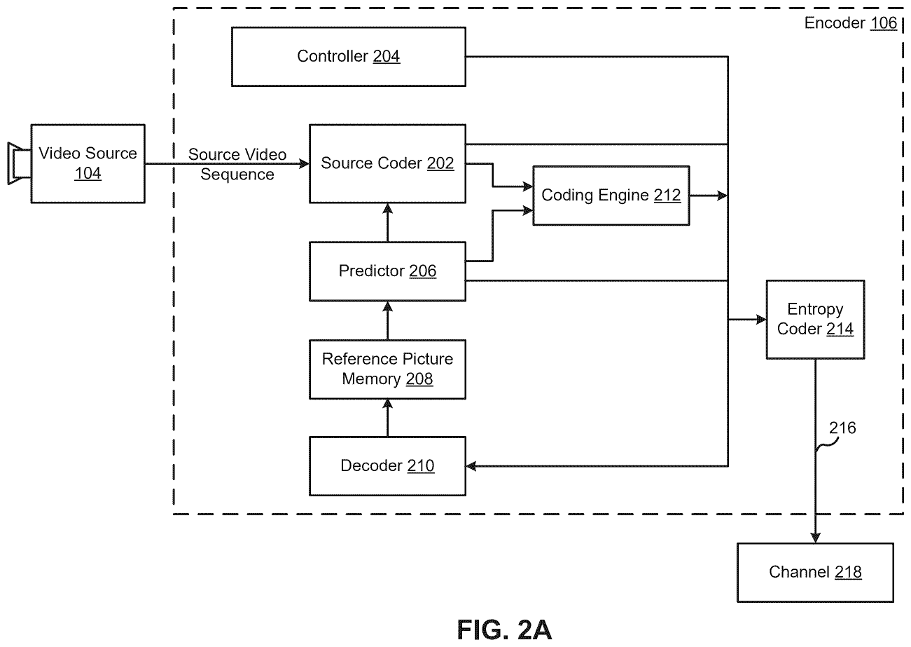

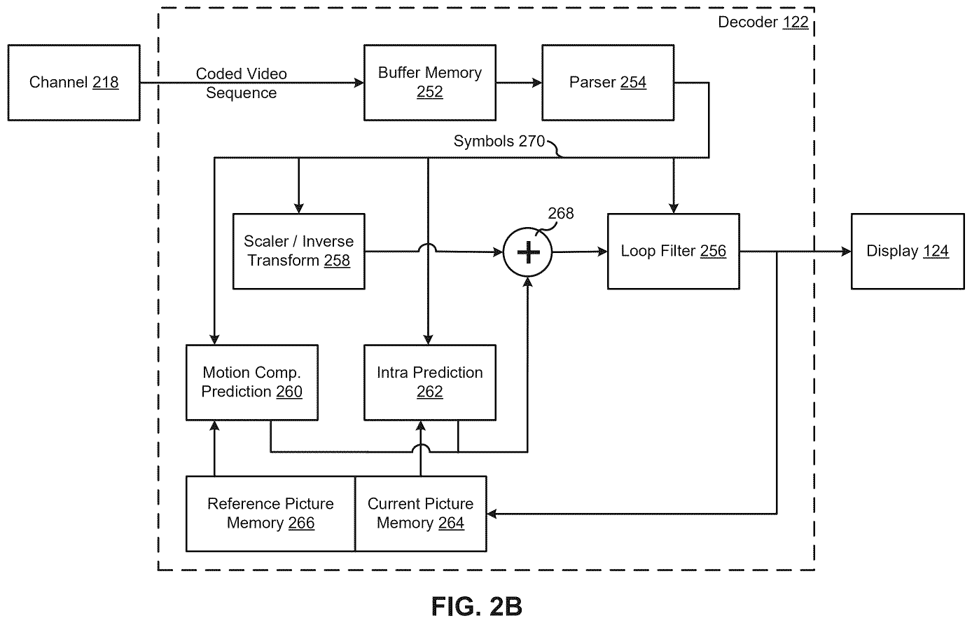

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

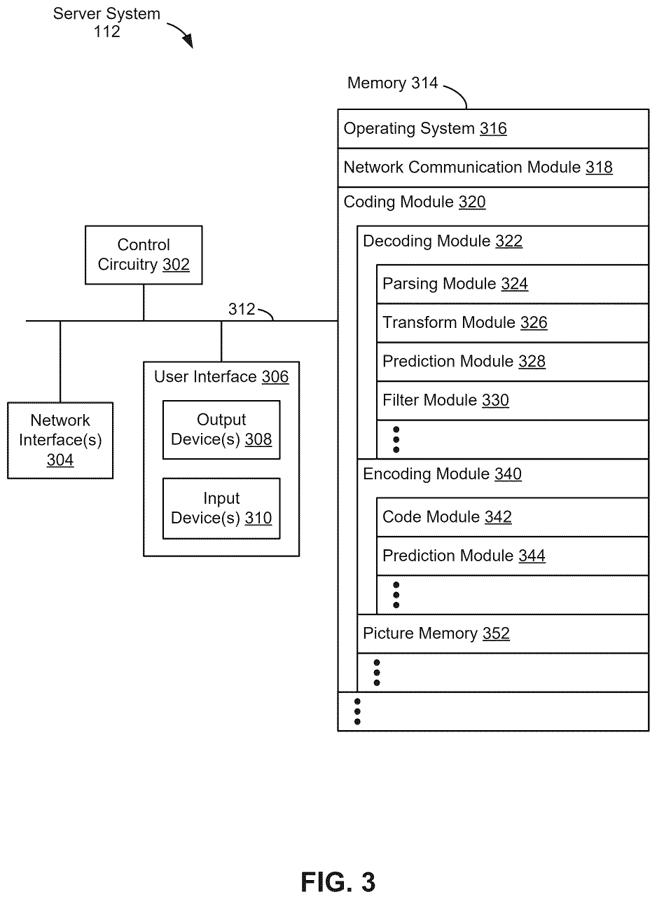

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). The present disclosure describes restricting the use of CfL mode based on luma and chroma partition types, e.g., to reduce latency between the decoding of the chroma block and the decoding of the collocated luma block as the decoding process of chroma blocks in the CfL mode may need to wait until the decoding process of collocated luma blocks is completed. Restricting the use of CfL mode may reduce hardware requirements, and may ensure that the chroma block only has to wait a maximum of 2048 luma samples to be reconstructed.

As used herein, the term “block” may refer to a coding block (such as super block, or largest coding unit, or coding tree block), a prediction block, a transform block, or a filtering unit. Additionally, a “subblock” of a block A refers to a block whose area is fully contained in the block A. Block shape can be referred to as a block width to height ratio, block area size, whether a block is a square block, a tall block or a flat block, and the like.

As used herein, the term “partitioning” may refer to splitting one coding block into a single or multiple smaller blocks. As described previously, general partitioning may start from a base block (e.g., a superblock or root node) and may follow a predefined ruleset, partition structure, and/or scheme. The partitioning may be hierarchical and/or recursive. After dividing or partitioning a base block using any of the example partitioning procedures or other procedures described herein, or the combination thereof, a final set of partitions or coding blocks may be obtained. Each of these partitions may be at one of various partitioning levels in the partitioning hierarchy, and may be of various shapes. Each of the partitions may be referred to as a coding block (CB), such partitions are referred to as coding blocks because they may form units for which some basic coding/decoding decisions may be made and coding/decoding parameters may be optimized, determined, and signaled in an encoded video bitstream. The highest or deepest level in the final partitions represents the depth of the coding block partitioning structure of tree. A coding block may be a luma coding block or a chroma coding block. The hierarchical structure of for all color channels may be collectively referred to as coding tree unit (CTU). The partitioning patterns or structures for the various color channels in a CTU may or may not be the same.

A region, or coding region, may be used to refer to any level in any one of the partitioning schemes described above or in other partitioning schemes not specifically described above. A region therefore may be a frame, a slice, a super block, a macroblock, a subblock, a prediction block, and the like. For example, a region may be any partitioning level of a recursive partitioning scheme.

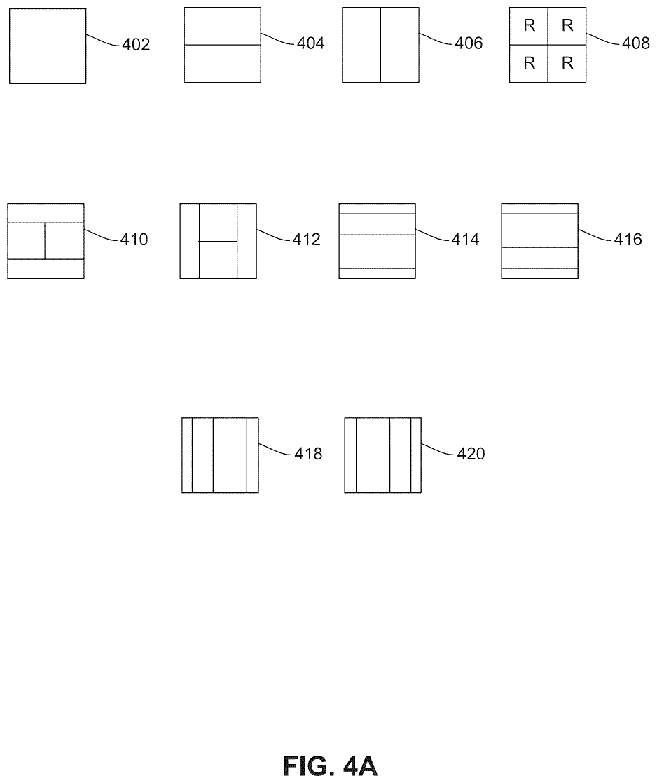

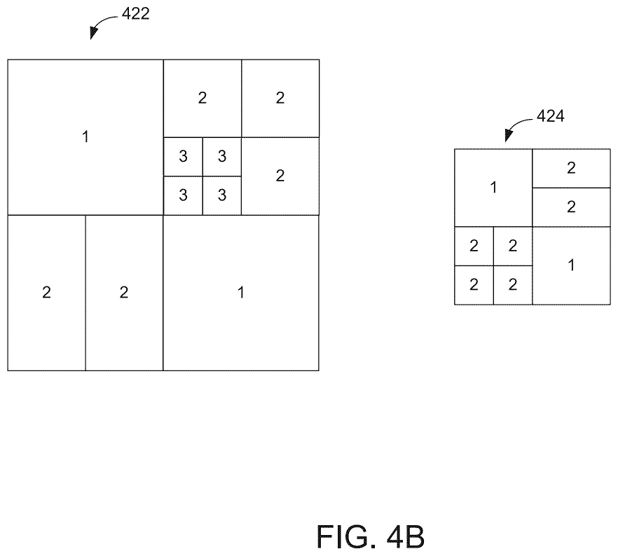

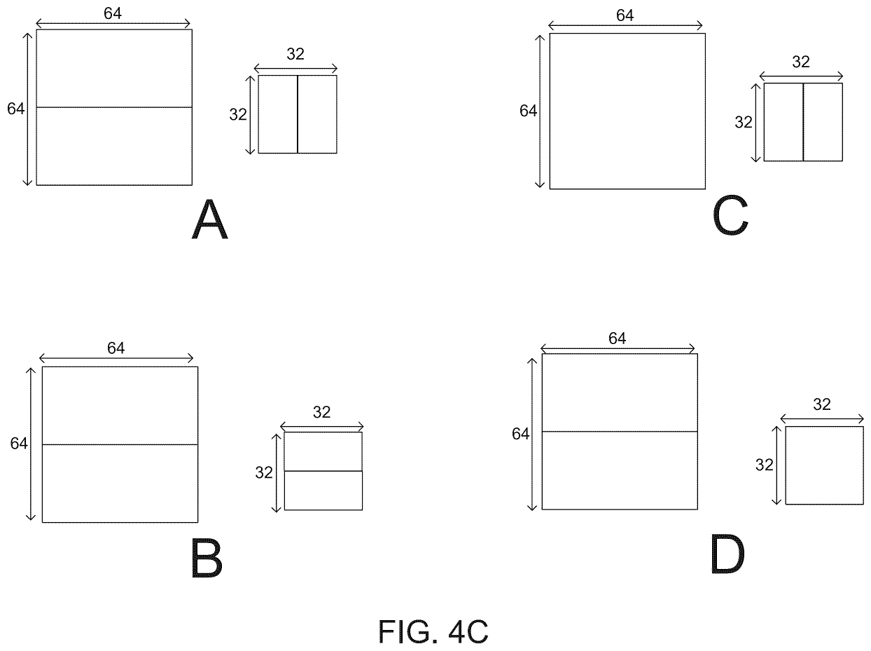

FIG. 4A shows various partition types and partitioning structures in accordance with some embodiments. The root block may start at a predefined level (e.g., from a base block at 128×128 or 64×64 level). As an example, block 402 is not further partitioned (“PARTITION_NONE”), block 404 is split into two equal horizontal partitions (“PARTITION_HORZ”), and block 406 is split into two equal vertical partitions (“PARTITION_VERT”). Block 408 is an example of a square split where a square is divided into four equal square blocks (“PARTITION_SPLIT”). Blocks 410 and 412 are H-partitions, with the block 410 being split into horizontal H partitions (“PARTITION_HORZ_3”), and the block 412 being split into vertical H partitions (“PARTITION_VERT_3”). The block 410 is horizontally split into three blocks with height ratio 1:2:1. The center block is further vertically split into two equally sized blocks. The block 412 is vertically split into three blocks with width ratio of 1:2:1. The center block is further horizontally split into two equally sized blocks.

FIG. 4A also shows partition types that include partitions from an uneven 4-way split/partitioning scheme that may be implemented horizontally, as shown in blocks 414 (“PARTITION_HORZ_4A”) and 416 (“PARTITION_HORZ_4B”), or vertically, as shown in blocks 418 (“PARTITION_VERT_4A”) and 420 (“PARTITION_HORZ_4B”). In particular, partition 414 is horizontally split into 1:2:4:1 regions. Block 416 is horizontally split into 1:4:2:1 regions. Block 418 is vertically split with 1:2:4:1 regions. Block 420 is vertically split with 1:4:2:1 regions.

As used herein, the phrase “a direction of the partition” may refer to the direction of the split of the first child. For example, the direction of PARTITION_VERT, PARTITION_VERT_3, PARTITION_VERT_4A and PARTITION_VERT_4B is vertical whereas the direction of PARTITION_HORZ, PARTITION_HORZ_3, PARTITION_HORZ_4A and PARTITION_HORZ_4B is horizontal.

As used herein, the phase “semi-decoupled partitioning” (SDP) may refer to a block region in which the luma block and a chroma block share the same partitioning information for the first N levels of the block partitioning and have separate block partitioning (e.g., different block partitions) starting from a partitioning point, called the decoupled partitioning point. The decoupled partitioning point may be implicitly determined based on the partitioning information of the luma block. FIG. 4B shows an example of semi-decoupled partitioning in accordance with some embodiments. The left side of FIG. 4B shows a coding tree structure for a luma component (e.g., a luma block 422) and the right side of FIG. 4B shows a coding tree structure for a chroma component (e.g., a chroma block 424). The numerical values within each block or subblock of the luma block 422 and the chroma block 424 in FIG. 4B indicate the depth of the block partitioning. As is shown, both the luma block 422 and the chroma block 424 share the quad-tree split (e.g., PARTITION_SPLIT, corresponding to the numeral “1”) at the beginning of the super block/coding tree structure. At a depth of 2, a lower left block of the chroma block 424 undergoes another quad-tree split, while an upper right block of the chroma block 424 undergoes a horizontal split (e.g., PARTITION_HORZ). In contrast, a lower left block of the luma block 422 undergoes a vertical split (e.g., PARTITION_VERT), while an upper right block of the luma block 422 undergoes another quad-tree split. The luma block 422 includes another partition at a depth of 4, where the lower left block of the quad-tree split from the depth of 2 is partitioned by yet another quad-tree split at a depth of 3. As a result, the coding tree structure of the luma block and the coding tree structure of the chroma block in FIG. 4B start to have separate block partitioning from that point or from block partitioning depth 1. In some approaches, SDP is applied to key frames and intra region in inter frames. With SDP, a luma block and a chroma block may have different block partitioning starting from 64×64.

As used herein, the phase “chroma-from-luma” or “chroma from luma” (CfL, or CFL) may refer to a methodology in which chroma block samples are predicted from the collocated luma block samples. In CfL mode, scaling factors may be explicitly signaled into the bitstream or implicitly derived from the neighboring reconstructed samples. Multi-hypothesis cross component prediction mode may also be considered as one type of CfL mode.

In some approaches, Chroma from Luma (CfL) is a chroma only coding tool that applies collocated luma reconstructed samples in predicting chroma samples. In the worst case, the decoding process of chroma blocks may need to wait until the decoding process of collocated luma blocks is completed. The systems and methods described herein may reduce the latency between decoding of the chroma block and the collocated luma block by restricting the use of CfL mode based on luma and chroma partition types.

In some embodiments, CfL is disallowed when the luma partition type and the chroma partition type do not satisfy one or more pre-defined conditions. In some embodiments, the one or more pre-defined conditions may be checked at the 64×64 block level and passed down to the leaf nodes. In some embodiments, the checking of the one or more pre-defined conditions may only be employed when luma and chroma are applying different partition types in key frames, and the checking of the condition may not be applied to inter frames.

As used herein, the phrase “region type” may refer to an enclosed set of luma and chroma blocks. When all of the luma blocks in the enclosed block set are intra coded, the region type may be referred to as INTRA. If at least one of the blocks in the enclosed set is inter coded, then the region type may be referred to as MIXED INTER INTRA.

In some embodiments, if any one of the following two conditions is met, CfL is allowed. If none of the following two conditions is met, CfL is disallowed. In some embodiments, the first of the two conditions is that the chroma partition is PARTITION_NONE. For example, if the chroma partition is PARTITION_NONE, CfL is allowed. In some embodiments, the second of the two conditions is that the chroma block splits in the same direction as the partition of the collocated luma block (e.g., irrespective of the direction of the transform partitions of the luma block). For example, if the chroma block splits in the same direction as the partition of the collocated luma, then CfL is allowed irrespective of the direction of the transform partitions of the luma block. As described above, PARTITION_HORZ, PARTITION_HORZ_3, PARTITION_HORZ_4A, PARTITION_HORZ_4B are considered to be in the same direction.

FIG. 4C shows a few examples of allowing or disallowing CfL in accordance with some embodiments. In example A, the 64×64 luma block is split horizontally (e.g., PARTITION_HORZ), while the 32×32 chroma block is split vertically (e.g., PARTITION_VERT). In some embodiments, due to the lack of a PARTITION NONE for the chroma block (e.g., failure to satisfy condition 1), and the different directionality of the splits (e.g., failure to satisfy condition 2), CfL is disallowed in example A. In example B, both the 64×64 luma block and the 32×32 chroma block are split horizontally (e.g., PARTITION_HORZ). In some embodiments, due to same directionality of the splits (e.g., satisfaction of condition 2), CfL is allowed in example B even though condition 1 is not satisfied (e.g., the lack of a PARTITION_NONE for the chroma block). In example C, the 64×64 luma block has a PARTITION NONE, while the chroma block is split vertically (PARTITION_HORZ). In some embodiments, due to the lack of a PARTITION NONE for the chroma block (e.g., failure to satisfy condition 1), and the different directionality of the splits (e.g., failure to satisfy condition 2), CfL is disallowed in example C. In example D, the 64×64 luma block is split horizontally (PARTITION_HORZ) while the 32×32 chroma block has a PARTITION NONE. In some embodiments, due to a PARTITION NONE for the chroma block (e.g., satisfaction of condition 1), CfL is allowed in example D.

In some embodiments, checking of the one or more conditions includes a second aspect. For the second aspect, when a luma partition is PARTITION_NONE at 64×64 in a key frame, the chroma block is always inferred as PARTITION_NONE.

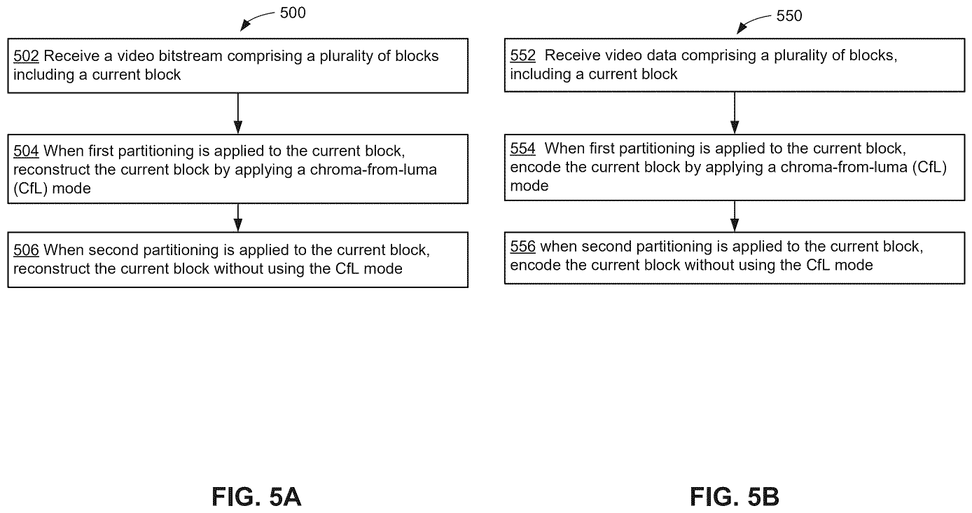

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) video bitstream (e.g., a coded video sequence) comprising a plurality of blocks (e.g., corresponding to a set of pictures) including a current block. When first partitioning is applied to the current block, the system reconstructs (504) the current block by applying a chroma-from-luma (CfL) mode. When first partitioning is applied to the current block, the system reconstructs (506) the current block without using the CfL mode. In this way, latency is reduced by selectively disallowing CfL for chroma blocks.

In some approaches, when a chroma block applies CFL, the decoder needs to wait for the availability of the collocated luma samples. In some embodiments, this latency is reduced by selectively disallowing CFL for chroma blocks. In some embodiments, disallowing CFL may depend on the region type of the current block. In some embodiments, CFL is allowed in inter frames when the region type is MIXED_INTER_INTRA.

In some embodiments, disallowing CFL may depend on the luma and/or chroma block partitions. In some embodiments, disallowing CFL may depend on the decoupled partitioning point between luma and chroma blocks. In some embodiments, CFL mode is allowed if the decoupled partitioning point is lower or equal to 32×32.

In some embodiments, disallowing CFL may depend on both luma and chroma partitions. In some embodiments, when luma and chroma have different partitions, CFL may be disallowed. Otherwise, when luma and chroma have the same block partitions, CFL mode is allowed.

In some embodiments, disallowing CFL may depend on the block size of the co-located luma block. In some embodiments, when both the block width and block height of the co-located luma block is equal to or greater than one threshold T1, CFL mode is disallowed for the chroma block. In one example, T1 is set to 64. In some embodiments, when the sample area size of the co-located luma block is equal to one threshold T2, CFL mode is disallowed for the chroma block. In one example, T2 is set to 64×32.

In some embodiments, disallowing CFL may depend on whether a chroma block partition is different from its co-located luma block partition. In some embodiments, when the chroma partition is different from the luma partition, CFL is allowed. In some embodiments, disallowing CFL may depend on the imposition of partitioning from luma and the block size. In some embodiments, when the chroma block is imposed with the luma partition and the block size T1, CFL is disallowed. In one example, T1 is 64×32. In some embodiments, disallowing CFL may depend on the imposition of partitioning from luma and the mapping between luma and chroma partitions. In some embodiments, if the chroma block is not imposed with the luma partition, a combination of the chroma block partition and its co-located luma block partitions may be used to derive the decision to disallow CFL.

In some embodiments, disallowing CFL may depend on the combination of chroma block partition and its co-located luma block partitions. This combination can be implemented by a look-up mapping table. In some embodiments, for a given luma partition A, CFL is allowed for leaf node situated on chroma partitions A, B, C. In one example, A, B and C can be (but not limited to) PARTITON_HORZ, PARTION_HORZ_3 and PARTITION_HORZ_4A. In some embodiments, the number of chroma partitions can be as many as the number of existing block partitions. In some embodiments, A can be any existing block partition.

In some embodiments, multiple partition mappings between Luma and Chroma may depend on the block size. In some embodiments, for a given Luma partition A, CFL is allowed for leaf node situated on Chroma partitions A, B, C only when the sample area size of the co-located luma block is equal to one threshold T1. In one example, A, B and C can be (but not limited to) PARTITON_HORZ, PARTION_HORZ_3 and PARTITION_HORZ_4A and T1 is set to 64×32.

In some embodiments, a look-up table may be used for multiple partition mappings between luma and chroma partitions and the co-located luma block size. In some embodiments, the look-up table may be used to retrieve multiple chroma partitions for a give luma partition A and block size T1. In some embodiments, a look-up table is used to retrieve PARTITION_VERT_4B, PARTITION_NONE and PARTITION_HORZ if A is PARTION_VERT_4B and T1 is 64×32. In some embodiments, the look-up table may be as shown in Table 1.

TABLE 1
Example depiction of look-up table to map luma and chroma partitions

| Luma Partition | Luma block size 64 × 64 | Luma block size 64 × 32 | Luma block size 32 × 64 |
|---|---|---|---|
| PARTITION_NONE | PARTITION_NONE, | PARTITION_NONE, | PARTITION_NONE, |
| | PARTITION_HORZ, | PARTITION_VERT, | PARTITION_HORZ, |
| | PARTITION_HORZ_3, | PARTITION_VERT_3, | PARTITION_HORZ_3, |
| | PARTITION_HORZ_4A, | PARTITION_VERT_4A, | PARTITION_HORZ_4A, |
| | PARTITION_HORZ_4B | PARTITION_VERT_4B | PARTITION_HORZ_4B |
| PARTITION_HORZ | PARTITION_HORZ, | PARTITION_HORZ, | All except |
| | PARTITION_NONE, | PARTITION_HORZ_3, | PARTITION_SPLIT |
| | PARTITION_HORZ_3, | PARTITION_HORZ_4A, | |
| | PARTITION_HORZ_4A, | PARTITION_HORZ_4B | |
| | PARTITION_HORZ_4B | | |
| PARTITION_VERT | PARTITION_VERT, | All except | PARTITION_VERT, |
| | PARTITION_VERT_3, | PARTITION_SPLIT | PARTITION_VERT_3, |
| | PARTITION_VERT_4A, | | PARTITION_VERT_4A, |
| | PARTITION_VERT_4B | | PARTITION_VERT_4B |
| PARTITION_HORZ_3 | PARTITION_HORZ_3, | PARTITION_HORZ_3, | PARTITION_HORZ_3, |
| | PARTITION_HORZ_4A, | PARTITION_NONE, | PARTITION_NONE, |
| | PARTITION_HORZ_4B | PARTITION_HORZ, | PARTITION_HORZ, |
| | | PARTITION_HORZ_4A, | PARTITION_HORZ_4A, |
| | | PARTITION_HORZ_4B | PARTITION_HORZ_4B |
| PARTITION_VERT_3 | PARTITION_VERT_3, | PARTITION_VERT_3, | PARTITION_VERT_3, |
| | PARTITION_VERT_4A, | PARTITION_NONE, | PARTITION_NONE, |
| | PARTITION_VERT_4B | PARTITION_VERT, | PARTITION_VERT, |
| | | PARTITION_VERT_4A, | PARTITION_VERT_4A, |
| | | PARTITION_VERT_4B | PARTITION_VERT_4B |
| PARTITION_HORZ_4A | PARTITION_HORZ_4A | PARTITION_HORZ_4A | PARTITION_HORZ_4A |
| PARTITION_HORZ_4B | PARTITION_HORZ_4B | PARTITION_HORZ_4B | PARTITION_HORZ_4B, |
| | | | PARTITION_NONE, |
| | | | PARTITION_HORZ |
| PARTITION_VERT_4A | PARTITION_VERT_4A | PARTITION_VERT_4A | PARTITION_VERT_4A |
| PARTITION_VERT_4B | PARTITION_VERT_4B | PARTITION_VERT_4B, | PARTITION_VERT_4B |
| | | PARTITION_NONE, | |
| | | PARTITION_HORZ | |

| | |
|---|---|
| PARTITION_SPLIT | Not Applicable |

In some embodiments, disabling CFL may depend on the look-up table. In some embodiments, when the chroma partition and the partition derived from the look-up table using the block size of the luma block and the luma partition are different, CFL is disallowed. In some embodiments, when the chroma partition and at least one of the partitions derived from the look-up table using the block size of the luma block and the luma partition are different, CFL is disallowed.

In some embodiments, disallowing CFL may depend on the luma tree. In some embodiments, CFL mode is disallowed for child nodes if the referencing between parent tree of the luma partition is disallowed by the encoder.

In some embodiments, disallowing CFL may depend on the parent tree. In some embodiments, CFL mode is disallowed if the leaf node does not have a parent tree. In some embodiments, disallowing CFL may depend on the parent tree of the luma partition. In some embodiments, CFL mode is disallowed for a leaf node at a block size T1 if the partition of the parent tree of collocated luma block is B. For example, T1 is set to 16×16, and B is PARTITION_HORZ.

In some embodiments, disallowing CFL may depend on the parent tree of the luma partition and the block partition of the current tree. In some embodiments, the mapping between parent tree of the luma partition and the block partition of the current tree applies a lookup mapping table (e.g., Table 1).

In some embodiments, disallowing CFL may depend on the combination between the embodiments described in the preceding paragraphs.

In some embodiments, the decoupled partitioning point between luma and chroma blocks is first checked before the other checks described above. In some embodiments, combining the decisions (e.g., determinations at various checks) may include applying logical operations. In some embodiments, if one of the conditions for block size of the co-located luma block, whether the chroma block partition is different from its co-located luma block partition or the combination of chroma block partition and its co-located luma block partitions returns true, CFL is allowed for that block. In some embodiments, the decision to disallow CFL is taken at each depth of the partition tree. In some embodiments, the decision to disallow CFL depends on the luma and/or chroma block partition. In some embodiments, the decision to disallow CFL is passed down to the child tree.

In some embodiments, disallowing CFL may depend on the decision taken at various partitions depths di, (i={1, 2, 3, 4, . . . n}, where n refers to the leaf node as selected by the encoder). In some embodiments, the decision taken to disallow CFL may be combined using logical operators. In some embodiments, when the decisions taken at d1, d3 and dN are false, true, and false, CFL is still allowed for the leaf node regardless of the decision taken at leaf node.

When a chroma block applies cross component prediction, such as CFL, the decoder needs to wait for the availability of the collocated luma samples. The methods described herein selectively allow or disallow cross component prediction mode for chroma blocks based on the block partition of the chroma blocks and the block partition and/or transform partition of the co-located luma blocks.

In some embodiments, cross component prediction is allowed for all the child nodes of chroma blocks at one partition node when the co-located luma and chroma blocks have the same block partition directions at the partition node. For example, the partition node can be 64×64, 32×64, 64×32, or 32×32

In some embodiments, the partition direction of horizontal binary split, horizontal H-shape, and horizontal uneven 4-way split (includes both horizontal uneven 4-way A split and uneven 4-way B split) is horizontal direction. In some embodiments, the partition direction of vertical binary split, vertical H-shape, and vertical uneven 4-way split (including both vertical uneven 4-way A split and uneven 4-way B split) is vertical direction. In some embodiments, cross component prediction is allowed for chroma blocks when the luma and chroma blocks have the same block partition directions from the first split at 64×64 (or 64×32 or 32×64) level. For example, at 64×64 level, luma is using horizontal binary split, and chroma is using horizontal H-shape split, and cross component prediction is allowed for all the child nodes for chroma block under this 64×64 node.

In some embodiments, when luma and chroma blocks have the same direction, either both horizontal directions or both vertical directions, at 64×64 (or 64×32 or 32×64) level, cross component prediction is enabled for chroma blocks regardless of the transform partition split of the luma blocks. In some embodiments, cross component prediction is disallowed for chroma blocks when the luma and chroma blocks have different block partition directions from the first split at 64×64 (or 64×32 or 32×64) level. For example, at 64×64 level, luma is using horizontal binary split, and chroma is using vertical H-shape split, and cross component prediction is not allowed for all the child nodes for chroma block under this 64×64 node.

In some embodiments, when chroma blocks are not split at 64×64 (or 64×32 or 32×64) block partition node, cross component prediction mode is allowed for all the nodes chroma blocks under this 64×64 (or 64×32 or 32×64) node regardless of the co-located luma block partition and transform partition.

In some embodiments, when there is no block partition split and no transform partition split for the co-located luma blocks at 64×64 (or 64×32 or 32×64) block partition node, cross component prediction mode is allowed for all the child chroma blocks under this 64×64 (or 64×32 or 32×64) block partition node regardless of the block partition for chroma blocks.

In some embodiments, when there is no block partition split at 64×64 (or 64×32 or 32×64) block partition node for co-located luma blocks, the transform partition direction for luma blocks is X, either horizontal or vertical, and the block partition of the chroma blocks at 64×64 (or 64×32 or 32×64) block partition node is perpendicular to X, cross component prediction is not allowed for chroma blocks.

In some embodiments, when there is no block partition split at 64×64 (or 64×32 or 32×64) block partition node for co-located luma blocks, the transform partition direction for luma blocks is quad-tree split, and the block partition of the chroma blocks at 64×64 (or 64×32 or 32×64) block partition node is one kind of partition split, cross component prediction is not allowed for chroma blocks.

In some embodiments, when there is no block partition split at 64×64 (or 64×32 or 32×64) block partition node for co-located luma blocks, the transform partition direction for luma blocks is quad-tree split, and the block partition of the chroma blocks at 64×64 (or 64×32 or 32×64) block partition node is not partition_none and horizontal split, cross component prediction is not allowed for chroma blocks.

In some embodiments, cross component prediction is allowed for all the child nodes of chroma blocks at 64×64 (or 64×32 or 32×64) level when the co-located luma and chroma blocks have the same block partition directions at 64×64 (or 64×32 or 32×64) level.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a plurality of blocks (e.g., corresponding to a set of pictures) including a current block. When first partitioning is applied to the current block, the system encodes (554) the current block by applying a chroma-from-luma (CfL) mode. When second partitioning is applied to the current block, the system encodes (556) the current block without using the CfL mode. As described previously, the encoding process may mirror the decoding processes described herein (e.g., usage of the CfL mode). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

Simulation data on AVM v9 anchor for all-intra, random access, and low delay configurations has shown that restricting the use of CfL mode based on luma and chroma partition types to reduce latency between the encoding or decoding of the chroma block and the collocated luma block results in 1% encoding time saving, 3% decoding time saving, and only 0.09% coding loss for All Intra mode; 1% encoding time saving and 2% decoding time saving and only 0.04% coding loss for Random Access mode; and 1% encoding time saving and 3% decoding time saving, and only 0.02% coding loss for Low Delay mode. Simulation data on AVM v10 anchor for all-intra, random access, and low delay configurations shows a 1% encoding time increase, no decoding time saving, and 0.05% coding loss for All Intra mode; no encoding time increase, 1% decoding time increase and only 0.02% coding loss for Random Access mode; and 2% encoding time saving and 1% decoding time increase, and 0.03% coding gain for Low Delay mode.

(A1) In one aspect, some embodiments include a method (e.g., the method 500) of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks including a current block; when first partitioning is applied to the current block, (ii) reconstructing the current block by applying a chroma-from-luma (CfL) mode; and when second partitioning is applied to the current block, (iii) reconstructing the current block without using the CfL mode. In this way, latency is reduced by selectively disallowing CfL for chroma blocks. For example, disallowing CfL may depend on the luma and/or chroma block partitions. In some embodiments, the first partitioning comprises no partitioning (e.g., PARTITION_NONE) being applied to the current block (e.g., being applied to a chroma component and/or luma component of the current block). In some embodiments, whether to disable CfL mode is based on a look-up table (e.g., mapping partition types). In some embodiments, the condition checking is performed at a 64×64 block level and passed down to leaf nodes. In some embodiments, the condition checking is only employed when luma and chroma are applying different partition types in key frames, and the condition checking is not applied to inter frames. In some embodiments, the first partitioning comprises chroma splitting in the same direction as the partition of the collocated luma block, e.g., irrespective of transform partition directions. In some embodiments, partitions having the same direction include PARTITION_HORZ, PARTITION_HORZ_3, PARTITION_HORZ_4A, and PARTITION_HORZ_4B. In some embodiments, partitions having the same direction include PARTITION_VERT, PARTITION_VERT_3, PARTITION_VERT_4A, and PARTITION_VERT_4B.

(A2) In some embodiments of A1, the first partitioning comprises a luma component of the current block having the same partitioning as a chroma component of the current block. For example, disallowing CfL may depend on both luma and chroma partitions. In some embodiments, when chroma is different from luma partition, CfL is allowed. In some embodiments, when luma and chroma have the same block partitions, CfL mode is allowed. In some embodiments, the first partitioning comprises both the luma component and chroma component having PARTITION_NONE. In some embodiments, the first partitioning comprises both the luma component and chroma component having the same directional partition type.

(A3) In some embodiments of A1 or A2, the second partitioning comprises the luma component having a different partitioning than the chroma component. For example, when luma and chroma have different partitions, CfL may be disallowed. Otherwise, when luma and chroma have the same block partitions, CfL mode is allowed. In some embodiments, the second partitioning comprises the luma component having a horizontal partition while the chroma component has a vertical partition. In some embodiments, the second partitioning comprises the luma component having PARTITION_NONE while the chroma component has a directional partition. In some embodiments, the second partitioning comprises different partition directions between the luma and chroma components.

(A4) In some embodiments of any of A1-A3, the current block is within a current region; and the method further comprises: when the current region has a first region type, reconstructing the current block by applying the CfL mode; and when the current region has a second region type, reconstructing the current block without using the CfL mode. For example, disallowing CfL may depend on the region type of the current block. In some embodiments, the first region type comprises an intra region type where all luma blocks in an enclosed block set are intra coded. In some embodiments, the second region type comprises a region where at least one block in an enclosed set is inter coded.

(A5) In some embodiments of A4, the first region type comprises a mixed inter-intra region type. For example, CfL is allowed in inter frames when the region type is MIXED INTER INTRA. In some embodiments, CfL is allowed in inter frames only when the region type is MIXED_INTER_INTRA. In some embodiments, the mixed inter-intra region type includes both intra-coded and inter-coded blocks within the same region.

(A6) In some embodiments of any of A1-A5, the first partitioning comprises a semi-decoupled partitioning (SDP) mode with a first decoupling point, and wherein the second partitioning comprises the SDP mode with a second decoupling point. For example, disallowing CfL may depend on the decoupled partitioning point between luma and chroma blocks. As an example, CfL mode is allowed if the decoupled partitioning point is lower than or equal to 32×32. In some embodiments, the SDP mode is applied to key frames and intra regions in inter frames. In some embodiments, with SDP, luma and chroma have different block partitioning starting from 64×64. In some embodiments, luma and chroma share the same partitioning information for the first N levels of block partitioning and have separate block partitioning starting from the decoupling point. In some embodiments, the decoupling point is implicitly determined based on the luma block partitioning information. In some embodiments, the first decoupling point is at a 64×64 level. In some embodiments, the second decoupling point is at a level smaller than 64×64.

(A7) In some embodiments of any of A1-A6, the first partitioning comprises partitioning of a luma component of the current block and partitioning of a chroma component of the current block. For example, disallowing CfL may depend on both luma and chroma partitions. As an example, disallowing CfL may depend on the combination of chroma block partition and its co-located luma block partitions. This combination can be implemented by a look-up mapping table. For example, for a given luma partition A, CfL is allowed for leaf node situated on chroma partitions A, B, C. In one example, A, B and C can be (but not limited to) PARTITON_HORZ, PARTION_HORZ_3 and PARTITION_HORZ_4A. In another example, the number of chroma partitions can be as many as the number of existing block partitions. For example, A can be any existing block partition. In some embodiments, the partitioning includes PARTITION_SPLIT for splitting a square coding block into four square blocks. In some embodiments, the partitioning includes PARTITION_VERT for vertically splitting a coding block into two equally sized blocks. In some embodiments, the partitioning includes PARTITION_HORZ for horizontally splitting a coding block into two equally sized blocks. In some embodiments, the partitioning includes PARTITION_VERT_3 for vertically splitting a coding block into three blocks with width ratio 1:2:1, where the center block is further horizontally split into two equally sized blocks. In some embodiments, the partitioning includes PARTITION_HORZ_3 for horizontally splitting a coding block into three blocks with height ratio 1:2:1, where the center block is further vertically split into two equally sized blocks. In some embodiments, the partitioning includes uneven 4-way partitioning schemes such as PARTITION_VERT_4A, PARTITION_VERT_4B, PARTITION_HORZ_4A, and PARTITION_HORZ_4B.

(A8) In some embodiments of A7, the first partitioning corresponds to a mapping between the partitioning of the chroma component and the partitioning of the luma component.

In some embodiments, multiple partition mapping between luma and chroma may depend on the block size. For example, for a given luma partition A, CfL is allowed for leaf node situated on chroma partitions A, B, C only when the sample area size of the co-located luma block is equal to a threshold, T1. In one example, A, B and C can be (but not limited to) PARTITON_HORZ, PARTION_HORZ_3 and PARTITION_HORZ_4A and T1 is set to 64×32. In some embodiments, a look-up table may be used for multiple partition mapping between luma and chroma partitions and the co-located luma block size. As an example, the look-up table may be used to retrieve multiple chroma partitions for a give luma partition A and block size T1. In one example, look-up table is used to retrieve PARTITION_VERT_4B, PARTITION_NONE and PARTITION_HORZ if A is PARTION_VERT_4B and T1 is 64×32. Table 1 illustrates an example of such a look-up table. As an example, when the chroma partition and the partition derived from the look-up table using the block size of the luma block and the luma partition are different, CFL is disallowed. As another example, when the chroma partition and at least one of the partitions derived from the look-up table using the block size of the luma block and the luma partition are different, CFL is disallowed. In some embodiments, the look-up table includes mappings for luma block sizes of 64×64, 64×32, and 32×64. In some embodiments, the look-up table maps different luma partition types to corresponding allowed chroma partition types based on the luma block size. In some embodiments, for PARTITION_NONE luma partition at 64×64 block size, allowed chroma partitions include PARTITION_NONE, PARTITION_HORZ, PARTITION_HORZ_3, PARTITION_HORZ_4A, and PARTITION_HORZ_4B.

(A9) In some embodiments of any of A1-A8, the method further comprising: when a luma component of the current block has a first size, reconstructing the current block by applying the CfL mode; and when the luma component of the current block has a second size, reconstructing the current block without using the CfL mode. For example, disallowing CfL may depend on the block size of the co-located luma block. As an example, when both the block width and block height of the co-located luma block is equal to or greater than a threshold, T1, CfL mode is disallowed for chroma block. For example, T1 may be set to 32, 64, or 128. As another example, when the sample area size of the co-located luma block is equal to a threshold, T2, CfL mode is disallowed for chroma block. For example, T2 may be set to 64×64, 32×32, or 64×32. In some embodiments, disallowing CfL depends on the imposition of partition from luma and the block size. For example, when chroma is imposed with luma partition and the block size, T1, CfL is disallowed. In one example, T1 is 64×32. In some embodiments, the first size comprises a block size smaller than a predetermined threshold. In some embodiments, the second size comprises a block size equal to or greater than the predetermined threshold. In some embodiments, the predetermined threshold is set to ensure that the chroma block waits a maximum of 2048 luma samples to be reconstructed.

(A10) In some embodiments of any of A1-A9, the current block comprises a luma component and a chroma component, and wherein the first partitioning comprises an imposition of partition from the luma component of the current block and mapping between partitioning of the luma component and the chroma component. For example, disallowing CFL may depend on the imposition of partition from luma and the mapping between luma and chroma partitions. In some embodiments, when the chroma block is not imposed with the luma partition, a combination of the chroma block partition and its co-located luma block partitions may be used to derive the decision to disallow CfL. In some embodiments, the imposition of partition from luma occurs when the chroma component inherits the partitioning structure from the collocated luma component. In some embodiments, the mapping between luma and chroma partitions is determined based on a predetermined relationship or look-up table.

(A11) In some embodiments of any of A1-A10, the first partitioning comprises a luma tree for a luma component of the current block. For example, disallowing CFL may depend on the luma tree. As an example, CfL mode may be disallowed for the child nodes if the referencing between parent tree of the luma partition is disallowed by the encoder. In some embodiments, disallowing CfL depends on the parent tree. For example, CfL mode is disallowed if the leaf node does not have a parent tree. In some embodiments, disallowing CfL depends on the parent tree of the luma partition. For example, CfL mode is disallowed if the leaf node at a block size T1 if the partition of the parent tree of collocated luma block is B. in one example T1 is set to 16×16, and B is PARTITION_HORZ. As another example, disallowing CfL may depend on the parent tree of the luma partition and the block partition of the current tree. The “luma tree” may represent a hierarchical partitioning structure for the luma component. The “parent tree” may refer to a higher level in the partitioning hierarchy. The “leaf node” may refer to the final partition level in the hierarchical structure. In some embodiments, the mapping between parent tree of the luma partition and the block partition of the current tree applies the look-up mapping table described in other embodiments.

(A12) In some embodiments of any of A1-A11, the current block is reconstructed by applying CfL mode based on two or more of: (i) a decoupled partitioning point between luma and chroma components of the current block; (ii) whether the luma and chroma components have a same partitioning; (iii) a luma tree for the luma component; and (iv) a parent tree for the current block. For example, whether to apply the CfL mode may be based on any combination of the factors described previously. In some embodiments, the decoupled partitioning point is checked first. In some embodiments, combining decisions may apply logical operations. For example, if one of (ii), (iii), or (iv) return true then, CfL is allowed for that block. In some embodiments, the combination of decisions uses logical AND operations. In some embodiments, the combination of decisions uses logical OR operations. In some embodiments, different weights may be applied to different factors when combining the decisions. In some embodiments, the decoupled partitioning point takes precedence over other factors in the decision-making process.

(A13) In some embodiments of any of A1-A12, the method further comprising determining whether to allow CfL at multiple depths in a partition tree for the current block. For example, the decision to disallow CfL is taken at each depth of the partition tree. In some embodiments, each determination is based on luma and/or chroma partitioning at the respective depth. In some embodiments, the decision to disallow CfL is passed down to a child tree. In some embodiments, disallowing CfL depends on a decision taken at various partitions depths dᵢ, (i={1, 2, 3, 4, . . . n}, where n refers to the leaf node as selected by the encoder). As an example, the decision taken to disallow CfL may be combined using logical operators. For example, when decisions taken at d1, d3 and dn are false, true and false, CfL may still be allowed for the leaf node regardless of the decision taken at leaf node. In some embodiments, the multiple depths correspond to different levels in a hierarchical partitioning structure. In some embodiments, the decision at a parent depth influences the decision at child depths. In some embodiments, the decision to allow or disallow CfL can be overridden at deeper levels based on specific conditions. In some embodiments, the logical operators include AND, OR, and NOT operations. In some embodiments, the decision-making process considers the cumulative effect of decisions across multiple depths.

(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a current block; (ii) when first partitioning is applied to the current block, encoding the current block by applying a chroma-from-luma (CfL) mode; and when second partitioning is applied to the current block, encoding the current block without using the CfL mode. In some embodiments, the method further includes transmitting encoded information for the current block in a video bitstream. In some embodiments, the encoding process mirrors the decoding process for CfL mode usage decisions. In some embodiments, the encoder applies the same condition checking as described for the decoding method. In some embodiments, the encoder performs the condition checking at 64×64 block level and passes the decision down to leaf nodes.

(B2) In some embodiments of B1, the first partitioning comprises a luma component of the current block having the same partitioning as a chroma component of the current block. In some embodiments, the same partitioning includes both components having PARTITION_NONE. In some embodiments, the same partitioning includes both components having the same directional partition type. In some embodiments, the same partitioning includes both components splitting in the same direction.

(B3) In some embodiments of B1 or B2, the second partitioning comprises the luma component having a different partitioning than the chroma component. In some embodiments, the different partitioning includes different partition directions between the luma and chroma components. In some embodiments, the different partitioning includes one component having PARTITION_NONE while the other has a directional partition. The different partitioning may result in CfL being disallowed to reduce latency.

(B4) In some embodiments of any of B1-B3, the first partitioning comprises partitioning of a luma component of the current block and partitioning of a chroma component of the current block. In some embodiments, the partitioning includes any of the partition types described in the decoding embodiments. In some embodiments, the encoder determines the optimal partitioning based on rate-distortion optimization while considering CfL restrictions.

(B5) In some embodiments of any of B1-B4, the method further comprises determining whether to allow CfL based on a look-up table mapping partition types. In some embodiments, the look-up table is the same as used in the decoding process. In some embodiments, the encoder uses the look-up table to make encoding decisions that will be compatible with the decoder's CfL restrictions.

(C1) In another aspect, some embodiments include a method of visual media data processing. In some embodiments, the method is performed at a computing system (e.g., the server system 112) having memory and one or more processors. In some embodiments, the method is performed at a coding module (e.g., the coding module 320). The method includes: (i) generating a video bitstream, including: (a) when first partitioning is applied to the current block, the current block is encoded by applying a chroma-from-luma (CfL) mode and (b) when second partitioning is applied to the current block, the current block is encoded without using the CfL mode; and (ii) transmitting the video bitstream including the encoded current block. The video bitstream comprises coded information for a plurality of blocks including a current block.

(C2) In some embodiments of C1, the first partitioning comprises a luma component of the current block having the same partitioning as a chroma component of the current block.

(C3) In some embodiments of C1 or C2, the second partitioning comprises the luma component having a different partitioning than the chroma component.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A13, B1-B5, and C1-C3, above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A13, B1-B5, and C1-C3 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
when first partitioning is applied to the current block, reconstructing the current block by applying a chroma-from-luma (CfL) mode; and
when second partitioning is applied to the current block, reconstructing the current block without using the CfL mode.

2. The method of claim 1, wherein the first partitioning comprises a luma component of the current block having the same partitioning as a chroma component of the current block.

3. The method of claim 2, wherein the second partitioning comprises the luma component having a different partitioning than the chroma component.

4. The method of claim 1, wherein the current block is within a current region; and
the method further comprises:
when the current region has a first region type, reconstructing the current block by applying the CfL mode; and
when the current region has a second region type, reconstructing the current block without using the CfL mode.

5. The method of claim 4, wherein the first region type comprises a mixed inter-intra region type.

6. The method of claim 1, wherein the first partitioning comprises a semi-decoupled partitioning (SDP) mode with a first decoupling point, and wherein the second partitioning comprises the SDP mode with a second decoupling point.

7. The method of claim 1, wherein the first partitioning comprises partitioning of a luma component of the current block and partitioning of a chroma component of the current block.

8. The method of claim 7, wherein the first partitioning corresponds to a mapping between the partitioning of the chroma component and the partitioning of the luma component.

9. The method of claim 1, further comprising:
when a luma component of the current block has a first size, reconstructing the current block by applying the CfL mode; and
when the luma component of the current block has a second size, reconstructing the current block without using the CfL mode.

10. The method of claim 1, wherein the current block comprises a luma component and a chroma component, and wherein the first partitioning comprises an imposition of partition from the luma component of the current block and mapping between partitioning of the luma component and the chroma component.

11. The method of claim 1, wherein the first partitioning comprises a luma tree for a luma component of the current block.

12. The method of claim 1, wherein the current block is reconstructed by applying CfL mode based on two or more of:
(i) a decoupled partitioning point between luma and chroma components of the current block;
(ii) whether the luma and chroma components have a same partitioning;
(iii) a luma tree for the luma component; and
(iv) a parent tree for the current block.

13. The method of claim 1, further comprising determining whether to allow CfL at multiple depths in a partition tree for the current block.

14. A method of video encoding performed at a computing system having memory and one or more processors, the method comprising:
receiving video data comprising a plurality of blocks, including a current block;
when first partitioning is applied to the current block, encoding the current block by applying a chroma-from-luma (CfL) mode; and
when second partitioning is applied to the current block, encoding the current block without using the CfL mode.

15. The method of claim 14, wherein the first partitioning comprises a luma component of the current block having the same partitioning as a chroma component of the current block.

16. The method of claim 15, wherein the second partitioning comprises the luma component having a different partitioning than the chroma component.

17. The method of claim 14, wherein the first partitioning comprises partitioning of a luma component of the current block and partitioning of a chroma component of the current block.

18. A non-transitory computer-readable storage medium storing a video bitstream that is generated by a video encoding method, the video bitstream comprising:
coded information for a plurality of blocks including a current block; and
wherein:
when first partitioning is applied to the current block, the current block is encoded by applying a chroma-from-luma (CfL) mode; and
when second partitioning is applied to the current block, the current block is encoded without using the CfL mode.

19. The non-transitory computer-readable storage medium of claim 18, wherein the first partitioning comprises a luma component of the current block having the same partitioning as a chroma component of the current block.

20. The non-transitory computer-readable storage medium of claim 19, wherein the second partitioning comprises the luma component having a different partitioning than the chroma component.
